(19) United States
(12) Patent Application Publication
(10) Pub. No.: US 2007/0074284 A1
(43) Pub. Date: Mar. 29, 2007

(54) Personal computer access control lockout

(76) Inventor: Kenneth M. Woog, Lake Forest, CA (US)

Correspondence Address: Donald W. Meeker;Patent Agent, 924 East Ocean Front #E, Newport Beach, CA, 92661, US

(21) Appl. No.: 11/224,565

(22) Filed: Sep. 12, 2005

(51) Int. Cl. G06F 12/14

(52) U.S. Cl. 726/16

(57) ABSTRACT

A box has an external plug insertable in a video output receptacle of a computer with internal screws from the box to side screw holes. Locking the box cover prevents access to the screws. An external video plug receptacle receives the plug from the display screen. An internal circuit between the external plug and receptacle has a programmable microcontroller, a real time clock, and internal battery to control the amount of time and time of day video signals are sent from the computer to the display screen.

### BACKGROUND OF THE INVENTION

1. Field of the Invention

The present invention relates to computer security systems and particularly to a personal computer access control lockout and timer for use in parental control of a child's viewing time of a computer monitor screen, said access control timer is a hardware switching device comprising a lockable box containing a timer, a switch, a microcontroller with a real time clock and back up battery; and which access control timer box further comprises a video plug receptacle for plugging a monitor into, a video plug for connection to the computer, and connection to the computer keyboard so that the device may be programmed and accessed.

2. Description of the Prior Art

The personal computer and the Internet have revolutionized the way we work, shop, play and communicate. Americans spend almost as much time on the computer as watching television, yet this has presented some new challenges. One of those challenges is moderation—keeping the computer use balanced with other important aspects of our lives. This is difficult enough for adults but for children keeping computer use in moderation can be an even bigger challenge.

The computer entertains our children with games, music, video, hobbies and information. It allows them to be with their friends via email, chat and instant message. It fills their time—distracting them from the daily struggles, and for many, their responsibilities. When computer use become excessive this can cause serious problems for the child and the household. Schoolwork effort and grades drop, arguments ensue about the computer use and fights can even breakout between siblings. Parents often respond by removing the computer, limiting use by taking the computer, keyboard or mouse away. This places these parents in a constant power struggle with their children over computer use. For working parents with unsupervised children at home, computer use limits cannot be enforced when they are not home.

While the personal computer has undoubtedly made a tremendously positive impact on society, there are many users that find themselves unable to limit the use of the personal computer and overuse results in difficulties in many areas of their functioning. Declining academic/occupational levels, social isolation, depression and anxiety are just some of the problems associated with excess computer use. The term Computer or Internet Addiction has been recognized by certain mental health professionals and treatment programs have been created. Since the computer is often used for many important functions in our daily life (email, word processing, etc.) abstinence is not a viable option. Limiting computer use is the only viable option.

Adults must be able to self-limit their computer use but many children and adolescents lack the self-control and parents must monitor their child's computer use. This creates conflicts and power struggles between parents and child. Seriously addicted youths will make outrageous efforts to get unauthorized computer use. This includes, sneaking at night, keeping extra keyboards/mice/power cords and hacking into computer monitoring software. Computer Use Programs exist (i.e. Watchdog) that work in conjunction with the operating system (XP, NT, Win98) security and password systems to control and limit use. Unfortunately these programs are not foolproof and technically savvy teenagers easily bypass these types of systems. Attempts to restrict user security to prevent tampering with the control software results in a relatively unusable/restricted operating system. Programs and certain files can't be deleted, Task Manager (useful when programs crash) cannot be run and the Time/date can't be set except by the Administrator. The operating system recovery modes in various Windows versions easily allow the software to be overridden. Many parents are less computer savvy than their children and software solutions are likely to be overridden. While administrators in business networks running Windows NT can be relatively confident that their systems are secure from unauthorized use, home users cannot be so confident. Adolescents can be persistent and will research extensively ways to get around OS and system security, especially when their computer use is not directly observed.

In working with computer addicted adolescents and their parents, it was observed that parents had problems attempting to get their children to comply with limits on computer use. Parents attempt to use software solutions only to have these solutions easily overridden in less than 10 minutes by children that are not computer experts. There were situations where the software was reasonably configured but the adolescent tricked a parent into leaving the computer logged in as an Administrator. In this mode, the control software and even operating system password configuration was compromised. When the software solution is very secure, the burden in now placed on the parent/administrator to install all software, fix all computer/software problems. They often are less capable than their adolescent to deal with these issues.

It became apparent that no software solution will allow both a highly useable system and provide the kind of monitoring and security necessary to control/limit/monitor adolescent computer use.

While parental controls are provided by some Internet providers, they cannot monitor off-line use of the computer (i.e. games). There have been a few software products developed to help parents monitor and limit computer use. Several prior art software solutions for monitoring/controlling PC use vary in functionality and they all have the same fundamental flaw—they run on some form of Microsoft Windows Operating system. These programs while perhaps useful for young children are not effective with older teens since they are relatively easy to defeat.

U.S. Pat. No. 5,630,144, issued May 13, 1997 to Woog, discloses a desktop computer monitor power control, which uses a keyboard controller. A desktop computer power controller uses the keyboard controller of the computer to time the duration of keyboard or other input device inactivity and to assert a power control signal when the duration exceeds a predetermined threshold value. A power control unit coupled to the keyboard controller interrupts power to a peripheral device such as a video monitor when the duration of inactivity exceeds the threshold value. In an alternative embodiment, the power control unit switches the peripheral device into a low-power mode when the duration of inactivity exceeds the threshold value. Once in low-power mode, the keyboard controller switches the device back to normal mode upon detecting resumed activity on the keyboard or other input device. Applicants prior patent is for a keyboard/mouse inactivity monitor to control display power using a device internal to the PC and only monitors inactivity to blank the display. It does not provide external locked timer hardware.

U.S. Pat. No. 5,173,940, issued Dec. 22, 1992 to Lantz, discloses keyboard activated screen blanking. A keyboard controller is provided which scans entered input sequences for an input sequence to activate a display blanking feature. A password and particular hot key are loaded by the system microprocessor. The keyboard controller then scans until the designated sequence is activated. The display on the monitor is blanked until a password sequence is entered. The password mode may be directly activated from the system microprocessor. The display blanking feature is especially useful in conjunction with a keyboard password lock. Lantz is a keyboard operated screen blanking programming running in a PC and does not include locked hardware.

U.S. Pat. No. 6,748,542, issued Jun. 8, 2004 to Box, is for a timer operated hardware switching device for controlling the connection between a computer and telephone or data circuit. The device improves the security of the computer by limiting external access from the Internet or other networks. Security software programs such as fire walls are enhanced by the invention, which prevents electronic attacks during periods when the switching device is in the disconnected state. The device is simple to understand and can be easily verified in operation. Additionally, such a device can be used with conventional telephone applications to prevent calls from being made during specific time periods. The invention can be embodied as a standalone device, a device for use with a conventional power timer, and a device built into a computer or other computer accessory. Box does not describe an option of an external device for controlling a monitor.

U.S. Patent Application #20030191960, published Oct. 9, 2003 by Hung-Yi, describes a computer lock system with time-control function consists of a main program to supervise the right and time of using the computer system by authorized users, and a subprogram to process and store basic data such as the entry of the users for ID examination and the setting of time-limit for using the computer system. Said main program thereof, once checked by a BootRom chip on a protect card and executed in an operating system, will start an internal clock for time-control and a screen saver to keep the computer system locked in wait for the access of an authorized user passing the ID examination so as to protect the computer system from the illegal use of the crackers and secure the right of the users. When the time-limit of using the computer system is up, said main program thereof will restart said screen saver to keep the computer system locked again in wait for another legal user, thus efficiently protecting the right and regulating the time of using the computer system by the users. Besides supervising the operating system on PC, said computer lock system thereof can also combine with the operation of network to supervise and manage the computer systems on workstations. Hung-Yi is dependent on the OS, disc drives with hidden files or internal hardware for operation and used screen savers or other applications. This product can be defeated via software hacking. The present invention is external hardware and limits computer use by turning off the display.

U.S. Pat. No. 6,519,208, issued Feb. 11, 2003 to DeVries, describes a locking timer and outlet cover assembly for controlling access time for a television, video game, or computer, which employs a lockable enclosure box that attaches onto a wall outlet in place of the usual face plate. The volume inside the box encloses a standard 24-hour on-off timer. The box attaches to the outlet by the usual single screw. The cordset for the controlled device plugs into the timer, and then the cord exits the enclosure via a passage, such as a slit, but the slit does not permit passage of the plug. As an added safety feature, there can be a quick-disconnect plunger so that the timer device can be forced out (e.g., by wedge action) from the associated wall outlet. The plunger has a head portion extending outside the enclosure, and can be pushed in using the fingers. Once this is done, the timer cannot be plugged back in until the enclosure is unlocked and opened. DeVries is a locking AC timer. It does not help in dealing with monitor power cords since most monitors utilize removable cords—which are universal and readily available (ie. printer cord). This does not discriminate between users with individual password control. It does not control signals between the computer and a monitor.

U.S. Pat. No. 6,662,365, issued Dec. 9, 2003 to Sullivan, provides unified parental locks, in which a system and method are provided for controlling a plurality of parental control subsystems within an entertainment system. The system includes a computer interfaced to a plurality of audio and/or audiovisual devices, wherein at least two of the audio and/or audiovisual devices within the system each comprise a native parental control subsystem or locking mechanism having adjustable parameters. A software locking mechanism operates the computer to allow a user to input one or more general parental control parameters and then sets the adjustable parameters of each native parental control subsystem within the system by mapping the parental control parameters onto each separate, native mechanism for each device.

U.S. Pat. No. 6,643,777, issued Nov. 4, 2003 to Chu, shows a data security device and method for an attached computer module in a computer system. The security method reads a security identification number in an attached computer module and compares it to a security identification number in a console, which houses the attached computer module. Based upon a relationship between these numbers, a security status is selected. The security status determines the security level of operating the computer system. The Chu patent describes a security device that communicates and verifies security information between the computer and the security device that is attached. This is very different since the present invention does not send security information to or from the computer it is attached to.

U.S. Patent Application #20020007459, published Jan. 17, 2002 by Cassista, illustrates a method and apparatus for intentional blockage of connectivity. The apparatus is a device for the controlling or limiting of access to electronic networks, comprising a mechanical lock or other standard access control device (such as a numeric keypad, keylock switch, or biometric sensor), a switchable data connection, and an electronic means for detecting and reporting tampering attempts. Specifically, this method and apparatus is designed to be easy to understand and apply, and it inherently embodies simple but effective barriers to spoofing attempts. A timer automatically enables or disables the computer system, and an alarm can be also powered according to control codes. The user can select a desired function by pressing several buttons on the transmitter. The Cassista patent application describes a way of controlling access to a network.

U.S. Pat. No. 6,599,139, issued Jul. 29, 2003 to Hunter, claims a timer connect-disconnect for telephone, cable and network connections. A secure programmable timer allows connections to the internet via a phone line or a network during a programmed specific time range. A timer is set to close the connection from a computer (or telephone) to the phone line or network during a programmed time span. The computer is not connected to the phone line or network outside of the programmed time span. A timer motor rotates a timer that has programmable devices that interact with a gear to close the connection between the computer and the phone/network line during the programmed time, and to open the connection at time not in the programmed time range. A cover is secured over the timer and connection to the phone/network line to prevent a bypass connection to the phone/network line. The Hunter patent describes a secure timer to allow specific time access to a telephone, cable or network connection.

What is needed is a highly secure method of controlling personal computer use through control of the signals which are being output to the video display unit (VDU) so that it does not interfere with any operating system function or any application and does provide parents or administrators the ability to control the amount time of computer usage allowed and between what hours of the day the computer can be used including unique settings for multiple users to allow parents or administrators to meet the needs of individual users.

### SUMMARY OF THE INVENTION

The purpose of the present invention is to provide a highly secure method of controlling personal computer use through control of the signals which are being output to the video display unit (VDU) so that it does not interfere with any operating system function or any application and does provide parents or administrators the ability to control the amount time of computer usage allowed and between what hours of the day the computer can be used including unique settings for multiple users to allow parents or administrators to meet the needs of individual users.

A related object of the present invention is to utilize an external hardware solution to provide this control, by controlling access to the video display as a way of limiting computer use allowed for a solution that is 1) external 2) does not interfere with the operating system or software and 3) can be locked to the PC video port and not easily defeated.

Another related object of the present invention is to connect the external hardware to the keyboard and keyboard port to provide a way of entering a password and provide power to the invention.

A further object of the present invention is to provide a lock box for a video output port of a computer which has a manual switching means, such as a key operated switching means, for switching signals on and off from the computer video output port to a display screen or monitor for a simplified inexpensive embodiment of the present invention.

One more object of the present invention is to provide an additional lock box for each additional video output port on a computer with no connection to the monitor to prevent a user from plugging into the additional video output ports when one of the video output ports has the switching means in a lock box locked onto the video output port.

In brief, the present invention works with computers that connect to external displays to provide control by turning off signals to the display when the user has run out of time or is unauthorized to use the computer. With the display output disabled, the user is effectively unable to operate the computer.

The present invention comprises a small lock box (that includes the necessary logic) that plugs into the VGA port on the personal computer and locks in place such that it cannot be removed from the computer without the proper key. It also attaches to the keyboard and the keyboard port of the computer to allow entry of installation and configuration data and user passwords and to provide operating power. This attachment is accomplished via two cables that lead out of the invention's case. One cable includes a PS/2 keyboard type plug attached (to plug into the PC). The other cable includes a PS/2 keyboard socket allowing the keyboard to be plugged into it.

The present invention contains its own real time clock, memory and backup battery for keeping track of user passwords and privileges. Configuration, setup, and installation are accomplished by running a text editor on the PC. The PC Timer sends keyboard codes to the PC which will be received and displayed by the text editor (i.e. Wordpad) as menus and status displays. Keys pressed on the keyboard are received by the present invention and provide input to the setup and password functions of the present invention.

The present invention allows parents to moderate their children's computer use with a minimum of effort and struggle. The present invention cannot be removed from the computer without removing the lock even if the computer's case is opened.

To operate, users enter their user number and password on the keyboard. The user can operate the computer, with no limitations while authorized, otherwise the display output is disabled. Parents can moderate their children's usage by limiting the amount of time the child can use the computer and the times of day that use is allowed. A setting option allows no computer use for a user until the parent manually enables use each day (i.e. once homework is complete).

Installation is quick and easy and requires only a Phillips screwdriver to attach the present invention to the computer. Setup/configuration only requires a text editor running on the computer.

The present invention is compatible with all personal computers with an external VGA display (not notebook computers) and a PS/2 style keyboard. The present invention cannot be easily hacked and features an 18-gauge stainless steel tamper-resistant case. Except during setup, it operates independent of the computer's operating system or any computer applications. It contains its own secure battery-backed real time clock and provides on-screen prompts to assist in entering passwords and settings. It uses the on-screen graphic-display to indicate usage time remaining and to warn the user of time ending.

An advantage of the present invention is that provides secure, timed control of the display independent of the computer internal BIOS software, internal hardware, OS, application software, memory or disk drives.

Another advantage of the present invention is that it maintains its own time and security information.

A further advantage of the present invention is that it can be pre-configured and then installed on a system without access to the OS or internals of the computer.

One more advantage of the present invention is that it provides a locked connector assembly which cannot be removed without cutting the case or shackle to the lock.

Still another advantage of the present invention is that it provides an on-screen administrator setup and password prompt system requiring no software installation using an existing keyboard and display.

Yet another advantage of the present invention is that it allows the computer to continue to operate with audio features such as music players or AIM notification without using allowable time on the timer of the present invention.

An additional advantage of the present invention is that it allows sophisticated time limits by day of week.

Still another advantage of the present invention is that it allows lockout periods for homework, chores, etc.

Yet another advantage of the present invention is that it allows multiple users with different security settings.

One further advantage of the present invention is that it allows monitoring of how much time the computer is used by each user.

Yet one more advantage of the present invention is that it is highly secure and cannot be hacked, deleted, or overridden.

A further advantage of the present invention is that it works with any PC compatible operating system and could be configured and programmed to work with other operating systems.

Another advantage of the present invention is that it does not interfere with any hardware function or feature (except to enforce security features).

One additional advantage of the present invention is that it can be setup/configured for use by the dealer/retailer prior to shipment to allow use by novice computer users.

Yet another advantage of the present invention is that it allows fast switching between users does not require logging out of the operating system user.

One more advantage of the present invention is that it provides an easy administrator override to allow administrator to give extra time or make changes.

A significant advantage of the present invention is that it cannot be accidentally left in a mode in which settings can be changed.

A further advantage of the present invention is that it provides a simplified inexpensive embodiment of the present invention with a manual switching means.

One more advantage of the present invention is that it provides an additional lock box for blocking each additional video output port on a computer to prevent a user from plugging the monitor into the additional video output ports.

A final advantage of the present invention is that it can be removed at any time by an administrator.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of the external components of the preferred embodiment of the present invention aligned to connect between a computer and a display with a connection to the keyboard of the computer;

FIG. 2 is a flow diagram of the programmable timed VGA switching circuit of the preferred embodiment of the present invention of FIG. 1;

FIG. 2A is a flow diagram of a VGA switching circuit of an alternate simplified embodiment of the present invention with a manual switching means;

FIG. 3 is a diagrammatic view of the internal components of the box of the preferred embodiment of the present invention of FIG. 1;

FIG. 4 is a perspective view showing the outer end which attaches to a connection to a display screen or monitor and the bottom of the preferred embodiment of the present invention of FIG. 1;

FIG. 5 is a perspective view showing the inner end which attaches to a display screen or monitor connection and the top of the preferred embodiment of the present invention of FIG. 1;

FIG. 6 is a perspective view showing the outer end which attaches to a display screen or monitor connection and the bottom of an alternate embodiment of the present invention having a manual key switching means;

FIG. 7 is a perspective view showing the inner end which attaches to the video output port of a computer and the top of the alternate embodiment of the present invention of FIG. 6 showing the key switching means accessible through an opening in the cover;

FIG. 8 is a perspective view of an additional lock box which may be locked onto an additional video output port on the computer showing the outer end with just the lock tabs and no connection to any components and the bottom of the additional lock box;

FIG. 9 is a perspective view of the additional lock box of FIG. 8 showing the inner end which attaches to the video output port of a computer and the top of the additional lock box.

### BEST MODE FOR CARRYING OUT THE INVENTION

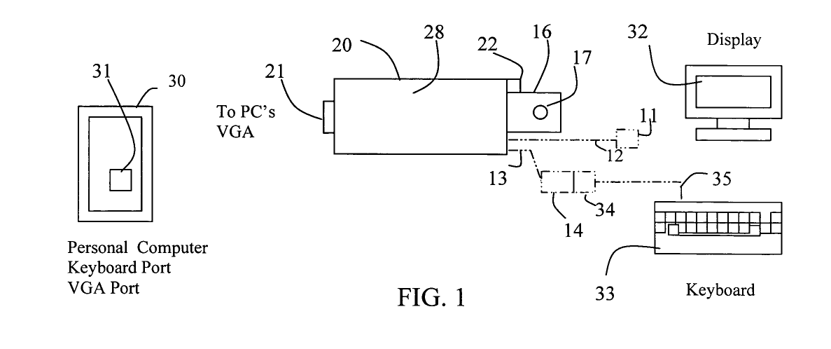

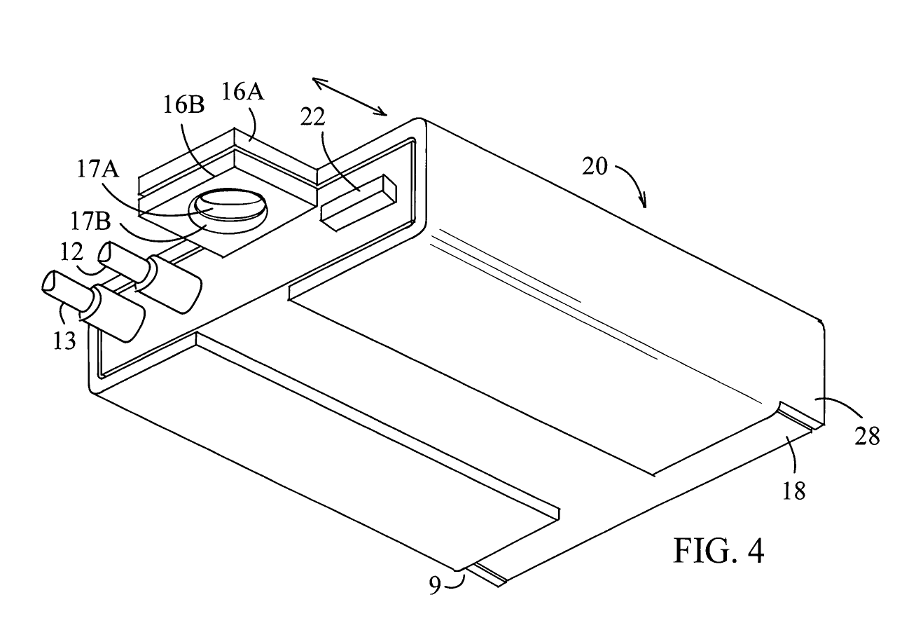

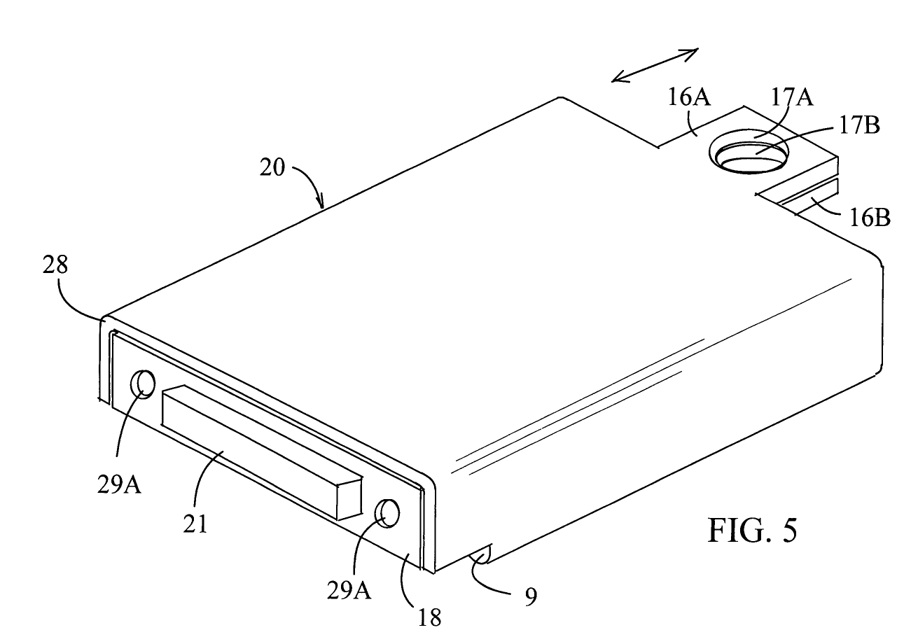

In FIGS. 1-7, a timed control device for controlling duration of computer usage functions by controlling signals between a computer and an external display with a lock box 20 and 20A attached to the video output of the computer. The lock box in each of the embodiments of the present invention comprises a tamper proof base 18 and a slidable tamper proof cover 28 covering the contents of the lock box with the cover 28 locked onto the base 18 and slidable in the direction of the arrows to open and close the lock box.

The device comprises a lock box 20 and 20A, preferably an 18-gauge stainless steel tamper-resistant case, which box comprises an external plug 21 insertable into a video output port 31 on a computer, an external receptacle 22 for a plug from a display device 32, such as a computer monitor external to the computer, an internal circuit 19 interconnecting the external plug 21 and external receptacle 22, the internal circuit comprising a microcontroller 24, a real time clock 25 which may be incorporated in the microcontroller, an internal power source 23, such as a button cell battery, for the time clock and the microcontroller, and a VGA switching circuit 27. The microcontroller comprises a microprocessor, memory and associated logic.

The microcontroller is programmable to connect and disconnect the internal circuit 19 between the external plug 21 and external receptacle 22 at programmable timed intervals for controlling display output from the computer 30 to the display 32. A means of locking the box 20 to the computer 30 is preferably a pair of screws 29 simulating the screws on a standard display plug, the screws operable from within the box and a removable cover 28 with a lock operated by a key which prevents access to the pair of screws when locked.

A means for receiving signals from a keyboard of the computer preferably comprises a first cable 12 and a PS/2 keyboard type plug 11 attached from the microcontroller 24 in the box 20 to the keyboard port 31 of the computer 30 and a second cable 13 and PS/2 keyboard socket 14 attached from the microcontroller to the keyboard plug 34 attached by a keyboard cable 25 to the keyboard 33. This allows entry of installation and configuration data and user passwords and operating power to provide keyboard input to the setup and password functions of the microcontroller, to provide control of the computer by turning off signals to the display when a user has run out of time or is unauthorized to use the computer so that with the display output disabled, the user is effectively unable to operate the computer, the microcontroller 24 programmable in conjunction with the real time clock 25 to control and monitor duration of use and time of day of use for a number of specified different users individually.

The microcontroller 24 comprises interface logic to connect to the keyboard and a simple power supply circuit that taps power from the keyboard port of the computer. The microcontroller 24 contains software to allow setup and operation of controlling and monitoring functions.

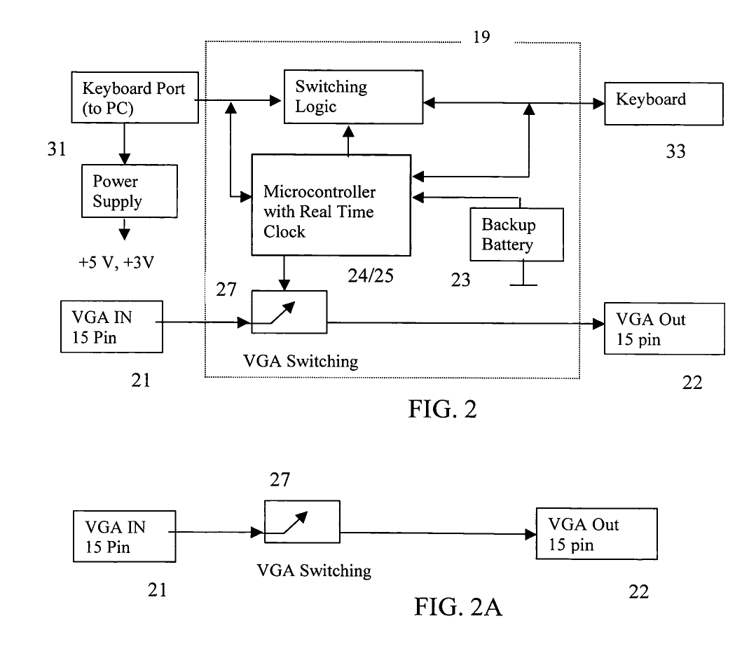

In FIG. 2, the internal circuit comprises a VGA switching circuit 27 and the microcontroller controls whether or not a VGA signal is passed from the external plug 21 to the external receptacle 22 by the VGA switching circuit 27. The VGA switching circuit 27 also comprises logic, in conjunction with the microcontroller 24, to send VGA signals to the external receptacle 22 to provide on-screen prompts on the display to assist in entering passwords and settings and to indicate usage time remaining and a warning to a user of time ending.

The microcontroller 24 functions independently of an operating system of the computer and functions independently of any computer applications.

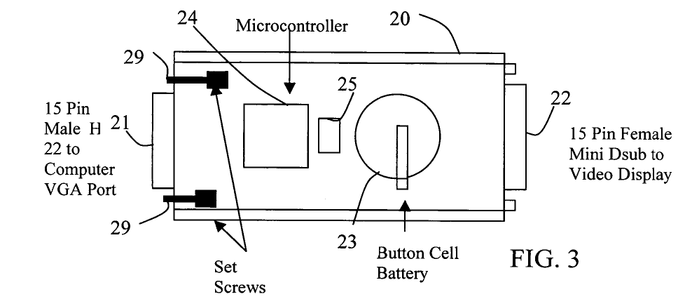

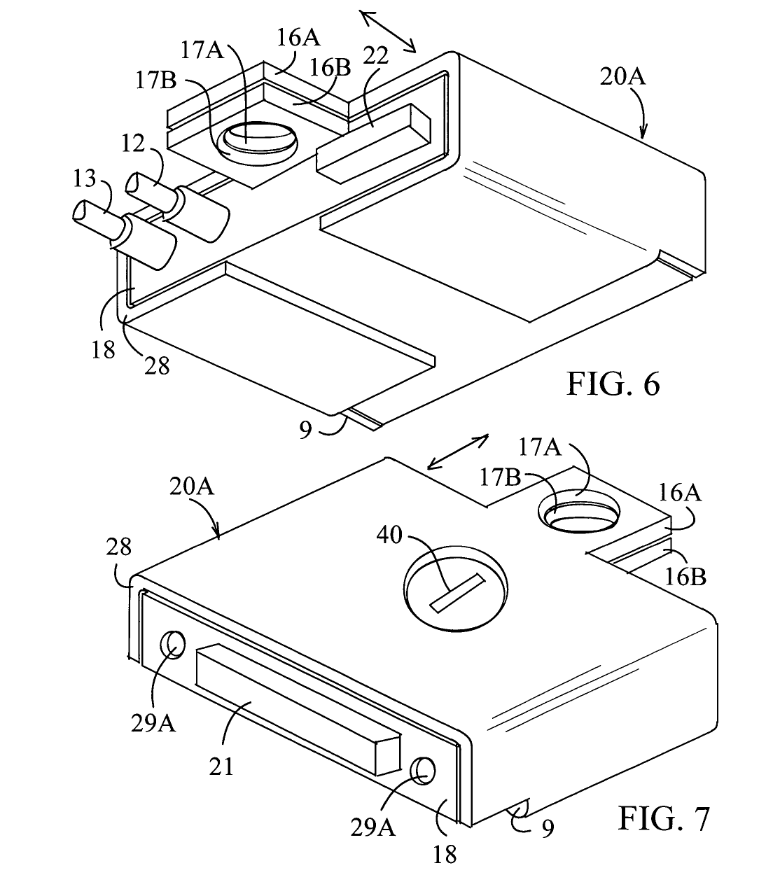

In FIGS. 6 and 7, a simple version of the lock box 20A provides a switching mechanism 27 which is manual to allow disabling of the video output by switching on and off between the external plug 21 to the VGA port and the external receptacle 22 to the display, illustrated in the flow diagram of FIG. 2A. A lockable key switch 40, is shown in FIG. 7, is preferably used to directly switch the video signals. The means of attaching the simple version of the lock box 20B to the computer comprises a pair of screws 29 simulating the screws on a standard display plug similar to those of FIG. 3. The unit would have two locks, one to lock access to the set screws by locking together the two tabs 16A and 16B with a hasp type lock and a second lock 40, preferably a key operated lock to switch the video signals, which second lock 40 could be operated through an opening in the cover 28 of the lock box. This would be a very inexpensive method of providing parental control over computer use.

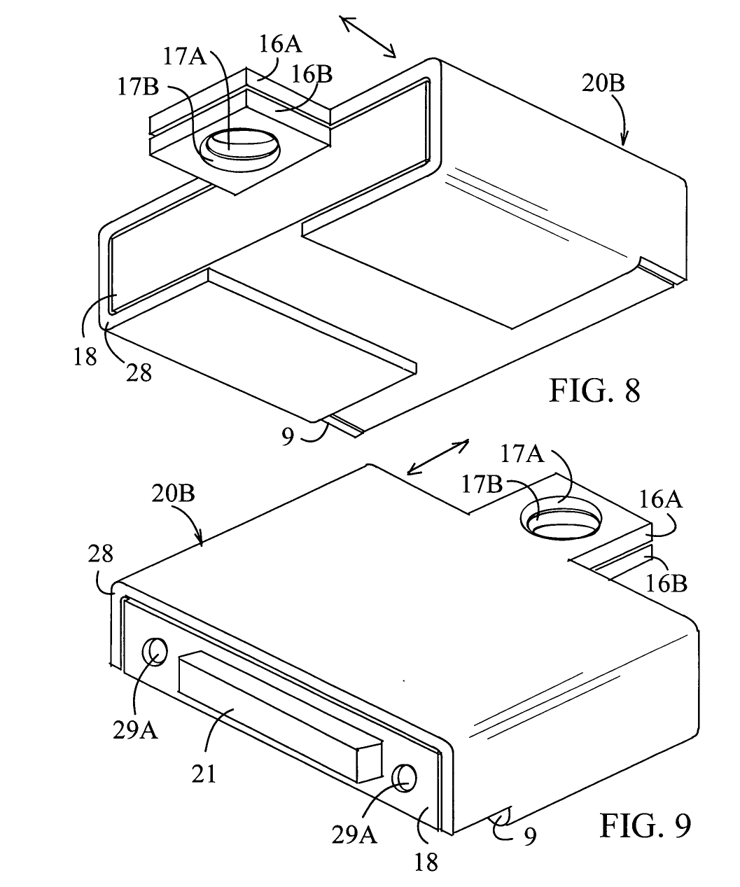

In FIGS. 8 and 9, the device of the present invention further comprises an additional lock box 20B for attaching to each additional VGA port of the computer. The means of attaching each additional lock box 20B to the computer comprises a pair of screws 29 simulating the screws on a standard display plug similar to those of FIG. 3, the screws operable from within the at least one additional lock box a locking means for the at least one additional lock box comprising a box tab 16B extending therefrom and a cover 28 for the at least one additional lock box comprising a cover tab 16A extending therefrom and the tabs having mating openings 17A and 17B therethrough, and the means of locking the cover comprises a hasp lock or other lock means through the two openings.

Rather than connect through the keyboard port, the invention could use the USB port and a USB keyboard. It also could contain its own keypad for entry of password information. The invention could also contain a display that could display the time remaining and setup and configuration information as it is being entered. It might also have a buzzer to provide audible warning of time running out.

Since the keystrokes are being monitored, computer use (when, how long, keystroke data) could be monitored to get an accurate idea of how much and when the computer is being used. This might be used to provide parents, administrators or therapist/counselors valuable information regarding the use patterns of the computer. Power on/off times could also be recorded and replayed to provide usage information.

In practice, the present invention plugs into (and is mechanically mounted to) the VGA port of a computer. The video display cable then connects to the connector on the VGA cable exiting the rear of the invention. This is how the invention intercepts the video signals. The invention also intercepts the keyboard signals by cabling to the PC's PS/2 keyboard port and to the keyboard itself.

The cover of the invention is open only for installation by screwing the set screws 29 into the computer and to change the battery 27. A jumper inside can also be removed temporarily in the event that the setup password was forgotten or otherwise unknown. Only when the cover is removed are the screws that attach the invention to the VGA port of the computer accessible. The present invention is installed by the following steps:
1. Turn off the personal computer and unplug the computer from the AC outlet.
2. Find the cable connecting the computer's VGA port to the video monitor/display. Remove the cable from the computer port by unscrewing the set screws, either by hand or with an appropriate screwdriver.
3. Remove the cover to the present invention by sliding the cover back toward the cables until it is off the base panel.
4. Identify the correct orientation and plug the present invention into the computer's VGA port (where the cable was previously disconnected). Note that the case of the present invention must be held in place in order to secure the screws in the next step. The present invention should plug in correctly. If not, try again with the box turned upside down. If it still does not plug-in, check to make sure you are plugging it into the VGA video connector and make sure that the connector is a 15 pin type and that pin 9 of the PC's VGA connector is not plugged (certain older PCs).
5. While holding the opened present invention in place, tighten the two mounting screws with a small Phillips screwdriver. Depending on the orientation of the present invention it may be more convenient to place the PC on its side in order to tighten the set screws.
6. Slide the cover of the present invention back on the base as far as it will go. If the cover does not slide on easily, make sure the internal wires do not interfere with the case cover. If the cover has been removed completely, the cables will need to be fed through the slit on the cover. Lock the cover to the base using one of the supplied keys. Note: Keep the keys in a safe place where users do not have access. This preferably should not be kept in the home unless you are absolutely sure that users cannot access the keys.
7. Attach the monitor cable to the VGA connector of the present invention. Tighten the set screws finger-tight.
8. Unplug the PS/2 style keyboard connector from the keyboard socket on the back of the computer. [Note: If your computer uses a USB style keyboard, you will need an adaptor]. Plug the keyboard into the short keyboard cable of the present invention.
9. Plug the long keyboard cable from the present invention into the keyboard socket on the computer (where the keyboard cable was unplugged).
10. Make sure the computer is upright and attach the power cable back to the computer. Power up the computer. The computer should power up normally. If no display appears or if the computer fails to power up refer, to the troubleshooting section of this manual. If blinking bars or a purple screen is displayed, the present invention has been previously installed and configured.

Once the present invention has been installed on the computer, it must be configured unless it has been preconfigured.
1. Power up the computer and let the operating system load completely. You may need to enter a password. Close all applications that might have loaded automatically. If there are any applications that may pop up automatically such as AIM (AOL Instant Messenger) or virus scanners, be sure to close them. You may need to click on icons in the system tray to disable various applications temporarily. This is important as the present invention setup works by sending keys as though you are typing to the text editor application. If the keys are sent to another application undesirable results may occur.

If the computer is password protected so you cannot run any applications, remove the present invention and install on another computer. Then follow the configuration steps listed below. Once configured, remove and install on the original computer. If this is one of your children's computers, suggest that they provide you with password access or you will not be able to change settings for holiday/vacations, etc.
2. Run a text editor application. Examples are Wordpad, Notepad (Windows) or Text Editor (Unix). Most text editors should work fine although some word processors may not. Make sure the text editor has “word wrap” enabled and maximized on the screen (full screen) otherwise the character formatting might be wrong and reading some of the text might be difficult.
3. While in the text editor application, press and quickly release the <Scroll Lock> key two times within 2 seconds. The screen should go blank and appear a dim purple. Press and quickly release the <T> key. The text editor should reappear and the setup program will begin after a short delay. Follow the on-screen instructions to set the clock, user passwords, amount of computer time and time ranges allowed each day for each user. Note that present invention displays the setup screen by generating keystrokes to the text editor application. Note that the mouse cannot be used to operate the setup program.
4. Once setup is complete, exit the text editor application and shut down the computer. Do not save the text file as prompted by the text editor.

When the computer is powered with the present invention installed and users configured, the display shows the power on test pattern for about 40 seconds. This pattern will include a bright then dimmed image of the display, full blue and red screens followed by a flashing blue screen (red indicates possible hacking attempt) that gets smaller over time. The keyboard is not disabled during this time. When the 40-second timeout elapses, the screen will show the Login prompt. The Login prompt is a small horizontal flashing red (normal mode) or purple (vacation mode) bar pattern that moves slowly down the screen. At any time during the 40 second timeout (flashing blue pattern) the user may press <Scroll Lock> twice (within 1 second) and the login prompt will be immediately displayed. It is recommended that the user does not type on the keyboard until sure that the keyboard has been properly initialized and the operating system is loading. Your child will probably want to wait before logging in otherwise they waste their allowed time waiting for the operating system to load. Typing on the keyboard immediately after powering the computer may create a start up error that could prevent the computer from powering up properly.

Each user must log in to the computer before the display will be enabled. This is accomplished at the login prompt, the flashing red (normal) or purple (the present invention is set to vacation mode) bars across the screen. Logging in is performed by selecting a user number by pressing a function key F1-F8 (users), F9 (parent) or F10 (setup) and then entering the associated password.

| State | Display | What to do next |
|---|---|---|
| Powerup | Blinking | Wait for login display or |
| | pattern | press <Scroll Lock> 2 times in 2 seconds |
| Login | Blinking bars | Press F1-F8 for users 1-8, F9 for parent) or |
| | across screen | F10 for setup |
| Password | Purple bar at | Enter password followed by <Enter> |
| | top of screen | |

While a user is logged-in, the duration of time used for that day and the current time is continually being monitored against the limit and range settings for the user for that day of the week. In order to provide warning that time is running out, the display will flash in various ways. At 10 and 5 minutes remaining, the display will flash briefly to alert the user of the upcoming time limit. When there is only 1 minute remaining, the display will flash continually once per second. After the remaining minute has elapsed, the display will turn off, the keyboard will be disabled and the display will return to the login screen as described in the previous section.

While a user is logged-in, the present invention can be easily prompted to provide status information on its operation. This information includes time remaining and reports on how much time has already been used. For remaining time, a graphic display using horizontal bars and red and blue colors can be evoked to report remaining time until shutoff. The time remaining will be amount of time until the display shuts off due to either running out of total time (daily limit) or reaching either an end of day range or a lock out period.

To invoke this graphic display, press the <Scroll Lock> key twice in two seconds. When the screen blanks with a dim purple screen, press the <Scroll Lock> key again and the graphic of remaining time will be displayed. This display consists of red and blue bars with a dimmed view of the current display in the background. The graphic starts at the bottom and extends upward. The upward length depends on how much time is remaining. The red bars signifies hours and the blue signifies 30 minute intervals. Each scan line of the display signifies approximately 1 minute. If more time remains than can be displayed, then the display will simply extend to the top of the screen. The display will timeout after a brief period or press the <Shift> key to end the display (don't press other keys as they will get passed to the application).

A display graphic gives a quick view of a relative sense of how much time is remaining. For a more exact report, the User Status Report may be invoked. The user must be running a text editor before invoking the report. To invoke this report, press the <Scroll Lock> key twice in two seconds. When the screen blanks and turns a dim purple, press the <Enter> key. The present invention will output the report by generating keystrokes to the text editor.

At any the user may log out by either turning off the computer or manually logging out. To log out manually, press the <Scroll Lock> key twice in two seconds. When the screen blanks and turns a dim purple, press the <Esc> (escape) key. The login screen will be immediately displayed.

In order to configure the users and preferences, the Setup program must be run. To enter setup, the Administrator user (F10) must log in and run a text editor application making sure that word wrap is enabled. Then the Administrator user presses <Scroll Lock> twice, waits for the dim purple screen and then presses the <T> key. The setup program will begin to run with the display generated by keystrokes sent by the present inventions to the text editor. Menus are provided to set the time of day, date, user passwords and names, operating hours, times and other security features. Once setup is complete, the Administrator presses the <0> key at any menu to exit setup and to log out.

There may be circumstances where additional time is needed. An example might be a late school project or as a special privilege. Rather than making permanent setting changes, an easy and quick method is provided to allow a one-time addition of between 10 and 90 minutes for a user regardless of the time limit or range settings. In order to allow bonus time, log in to setup (F10, password). Once logged in, press <Scroll Lock> twice to enter the option prompt with the dim purple display. Then press the numeric (1-9) key corresponding to the amount of time to added—<1> corresponds to 10 minutes, <2>=20 minutes, <3>=30, <9>=90 minutes, etc. Then press the function key of the user (F1-F8) that the bonus time is being added to. The display will return to the login prompt.

Bonus time can be an effective reward as long as it does not become a regular occurrence. When children are aware that the parent can add time easily, they may grow to demand it and may use various methods including tantrums in an attempt to get additional time. Using this feature more than once a week is not recommended.

User Daily Enable is a feature provided to allow parents/administrators to restrict computer use for the current day until they have specifically enabled the user. The feature resets each day. This allows the computer to be used as a reinforcement for the user completing less desirable tasks or responsibilities such as chores or homework. It can also be used to limit unattended computer use such as before parents return home from work.

After logging in as the Setup user (F10), press <Scroll Lock> twice. The display will blank and appear a dim purple (option prompt). Press the function key(s) of the user(s) (F1-F8) to be enabled for that day. Press <Esc> to exit from the option prompt and return to the login prompt.

The user can now log in (F1-F8, password) and use the computer according to the limit and range settings for that day. Once the user is logged in, the computer can be turned on and off that day without requiring re-enabling by the parent/administrator. However, if the computer is turned off before the user logs in, then the parent/administrator will need to re-enable for that day before the user can log in.

It is understood that the preceding description is given merely by way of illustration and not in limitation of the invention and that various modifications may be made thereto without departing from the spirit of the invention as claimed.

What is claimed is:

1. A control device for controlling usage of a computer by controlling signals between a computer and an external display, the device comprising:
a lock box comprising an external plug insertable into a video output port on a computer, an external receptacle for a plug from a display device external to the computer, an internal circuit interconnecting the external plug and external receptacle, the internal circuit comprising a switching means to connect and disconnect the internal circuit between the external plug and external receptacle for controlling display output from the computer to the display, a means of attaching the lock box to the computer with the external plug inserted in the video output port, the means of attaching positioned within the lock box, a removable cover for accessing the interior of the lock box, and a means of locking the cover on the lock box in a closed position to prevent access to the attaching means and thereby prevent removal of the lock box from the computer and to prevent tampering with the switching means by an unauthorized user, the device to provide control of the computer by turning off signals to the display when a user is unauthorized to use the computer so that with the display output disabled, the user is effectively unable to operate the computer.

2. The device of claim 1 wherein the internal circuit further comprises a timing means for controlling or monitoring duration of computer usage.

3. The device of claim 2 wherein said timing means comprises a real time clock and a microcontroller wherein said microcontroller comprises a microprocessor and associated memory.

4. The device of claim 3 wherein the microcontroller is programmable in conjunction with the real time clock to control or monitor duration of use and time of day of use for at least one user or a number of specified different users individually at programmable timed intervals.

5. The device of claim 4 wherein the microcontroller contains software to allow setup and operation of controlling or monitoring functions, said setup including passwords assigned to user(s).

6. The device of claim 5 further comprising a means for receiving signals from a keyboard of the computer to provide keyboard input to the setup and password functions of the microcontroller.

7. The device of claim 6 further comprising a means for sending signals to the keyboard port of the computer to provide, in conjunction with standard text editing software running on the computer, menu and display functions to the setup or monitoring functions of the microcontroller.

8. The device of claim 6 wherein the means for receiving signals from the keyboard comprises a cable and PS/2 keyboard socket attached from the microcontroller to the keyboard plug to allow entry of installation and configuration data and user passwords.

9. The device of claim 7 wherein the means for sending signals to the keyboard port of the computer comprises a cable and a PS/2 keyboard type plug attached from the microcontroller to the keyboard port of the computer to allow display of installation and configuration data and to provide operating power.

10. The device of claim 6 wherein the microcontroller comprises interface logic to connect to the keyboard.

11. The device of claim 7 wherein the microcontroller comprises interface logic to connect to the keyboard port of the computer.

12. The device of claim 3 wherein the internal circuit comprises a VGA switching circuit and the microcontroller controls whether or not a VGA signal is passed from the external plug to the external receptacle by the VGA switching circuit.

13. The device of claim 3 wherein the microcontroller functions independently of an operating system of the computer and functions independently of any computer applications.

14. The device of claim 3 wherein the microcontroller is programmed to provide on-screen prompts on the display to assist in entering passwords and settings and to indicate usage time remaining and a warning to a user of time ending.

15. The device of claim 3 wherein the internal circuit comprises a VGA switching circuit and the microcontroller controls whether or not a VGA signal is passed from the external plug to the external receptacle by the VGA switching circuit, the VGA switching circuit comprising logic, in conjunction with the microcontroller, to send VGA signals to the external receptacle to provide on-screen prompts on the display to assist in entering passwords and settings and to indicate usage time remaining and a warning to a user of time ending.

16. The device of claim 3 further comprising a power source for the real time clock and the microcontroller positioned inside the lock box.

17. The device of claim 1 wherein the means of attaching the lock box to the computer comprises a pair of screws simulating the screws on a standard display plug, the screws operable from within the lock box.

18. The device of claim 1 wherein the lock box further comprises a box tab extending therefrom and the cover further comprising a cover tab extending therefrom and the tabs having mating openings therethrough, and the means of locking the cover comprises a hasp lock through the two openings.

19. The device of claim 1 wherein the lock box comprises an 18-gauge stainless steel tamper-resistant case.

20. The device of claim 1 wherein the switching means of the internal circuit comprises a manual switching mechanism inside the lock box to enact disabling of the video output inside the lock box.

21. The device of claim 20 wherein the manual switching mechanism comprises a lock switch inside the lock box, the lock switch having a keyhole accessible from an exterior of the lock box.

22. The device of claim 1 further comprising at least one additional lock box for attaching to at least one additional video output port of the computer and a means of attaching the at least one additional lock box to the computer comprises a pair of screws simulating the screws on a standard display plug, the screws operable from within the at least one additional lock box a locking means for the at least one additional lock box comprising a box tab extending therefrom and a cover for the at least one additional lock box comprising a cover tab extending therefrom and the tabs having mating openings therethrough, and the means of locking the cover comprises a hasp lock through the two openings.
